(19) United States
(12) Patent Application Publication
(10) Pub. No.: US 2024/0403683 A1
(43) Pub. Date: Dec. 5, 2024

(54) CREATION OF NON-ABELIAN TOPOLOGICAL ORDER AND ANYONS ON A TRAPPED-ION PROCESSOR

(71) Applicant: Quantinuum LTD, London (GB)

(72) Inventors: Mohsin IQBAL, Munich (DE); Henrik DREYER, Munich (DE)

(21) Appl. No.: 18/635,403

(22) Filed: Apr. 15, 2024

Related U.S. Application Data
(60) Provisional application No. 63/496,547, filed on Apr. 17, 2023.

(51) Int. Cl. G06N 10/40

(52) U.S. Cl. CPC G06N 10/40

(57) ABSTRACT

A ground state of a non-Abelian topological order is prepared using physical qubits that are logically organized onto a lattice formed of a plurality of sublattices. Physical qubits assigned to respective vertices of a respective sublattice in a first subset of sublattices are entangled with plaquettes of the respective sublattice. The plaquettes of the respective sublattice in the first subset are measured. Physical qubits assigned to respective vertices of a respective sublattice in a second subset of sublattices are entangled with plaquettes of the respective sublattice. The plaquettes of the respective sublattice in the second subset are measured. Based on the plaquette measurements, a controller determines whether any plaquettes are hosting Abelian topological order. Responsive to determining that a plaquette is hosting Abelian topological order, the controller causes performance of a feed-forward action on the plaquette to generate the ground state of the non-Abelian topological order.

### CROSS-REFERENCE TO RELATED APPLICATIONS

This application claims priority to U.S. Application No. 63/496,547, filed Apr. 17, 2023, the content of which is incorporated herein by reference in its entirety.

### TECHNICAL FIELD

Various embodiments relate to preparation and/or generation of a ground state of a non-Abelian topological order using entangled quantum objects. For example, various embodiments relate to the generation or preparation of a ground state of a non-Abelian topological order using the physical qubits of quantum charge-coupled device (QCCD)-based quantum processor.

### BACKGROUND

Complex quantum computations demand levels of precision that are not available in conventional quantum computers. For example, conventional quantum computers are noise-limited due to imperfect control and noise in gate operations between data qubits, for example. Through applied effort, ingenuity, and innovation many deficiencies of prior systems have been solved by developing solutions that are structured in accordance with the embodiments of the present invention, many examples of which are described in detail herein.

### SUMMARY OF SOME EXAMPLE EMBODIMENTS

Various embodiments provide methods, systems, system controllers, and/or the like for preparing and/or generating a ground state of a non-Abelian topological order using entangled quantum objects. For example, various embodiments provide methods for preparing and/or generating a ground state of a non-Abelian topological order using a quantum charge-coupled device (QCCD)-based quantum processor.

According to a first aspect, a method for generating a ground state of a non-Abelian topological order is provided. In an example embodiment, the method includes causing a plurality of physical qubits to be confined within a confinement apparatus. The plurality of physical qubits is logically organized onto a lattice comprising a plurality of vertices connected by edges and a plurality of plaquettes. The lattice is formed of a plurality of sublattices. Each sublattice includes a respective three or more vertices of the plurality of vertices and a respective one or more plaquettes of the plurality of plaquettes. The respective three or more vertices and the respective one or more plaquettes of a sublattice of the plurality of sublattices are connected by edges to form the sublattice. The method further includes causing entanglement of vertex qubits of the plurality of physical qubits assigned to the respective three or more vertices of a respective sublattice in a first subset of sublattices with one or more plaquette qubits of the plurality of physical qubits assigned to the respective one or more plaquettes of the respective sublattice in the first subset of sublattices; and causing measurement of the one or more plaquette qubits assigned to the respective one or more plaquettes of the respective sublattice in the first subset of sublattices. The method further includes causing entanglement of physical qubits of the plurality of physical qubits assigned to the respective three or more vertices of a respective sublattice in a second subset of sublattices with one or more plaquette qubits of the plurality of physical qubits assigned to the respective one or more plaquettes of the respective sublattice in the second subset of sublattices; and causing measurement of the one or more plaquette qubits of the respective sublattice in the second subset of sublattices. The method further includes determining, based on the measurement of the one or more plaquette qubits of the respective sublattice in the first subset and the measurement of the one or more plaquette qubits of the respective sublattice in the second subset, whether any plaquettes of the plurality of sublattices are hosting an Abelian topological order; and responsive to determining that at least a pair of plaquettes of the plurality of sublattices is hosting an Abelian topological order, causing performance of a feed-forward action to be performed on the pair of plaquettes to generate the ground state having non-Abelian topological order.

In an example embodiment, the one or more plaquette qubits of each sublattice are in product state prior to the entanglement of the vertex qubits of the respective sublattice in the first subset of sublattices with the one or more plaquette qubits of the respective sublattice in the first subset of sublattices.

In an example embodiment, causing entanglement of the vertex qubits of the respective sublattice in the first subset of sublattices with the one or more plaquette qubits of the respective sublattice in the first subset of sublattices comprises causing entanglement between a particular plaquette qubit assigned to a particular plaquette of the respective one or more plaquettes and each of three vertex qubits assigned to vertices of the respective three or more vertices that are connected to the particular plaquette via edges of the sublattice and causing entanglement between another particular plaquette qubit assigned to another particular plaquette of the respective one or more plaquettes and the three vertex qubits assigned to the vertices of the respective three or more vertices that are connected to the particular plaquette via the edges of the sublattice, the three vertex qubits are also connected to the other particular plaquette via the edges of the sublattice.

In an example embodiment, causing entanglement between a particular plaquette qubit assigned to a particular plaquette of the respective one or more plaquettes and each of three vertex qubits that are each assigned to a respective vertex of the respective three or more vertices and that are connected to the particular plaquette and causing entanglement between another particular plaquette qubit assigned to another particular plaquette of the respective one or more plaquettes and the three vertex qubits that are each assigned to a respective vertex of the respective three or more vertices and that are connected to the other particular plaquette is implemented as four two-qubit gates.

In an example embodiment, the method further includes, prior to the measurement of the one or more plaquette qubits of the respective sublattice of the first subset of sublattices, causing entanglement of the plurality of plaquettes using pairs of three operator non-Clifford interactions.

In an example embodiment, a pair of three operator non-Clifford interactions is implemented as four two-qubit gates.

In an example embodiment, the lattice is a Kagome lattice.

In an example embodiment, causing the measurement of a plaquette qubit of the one or more plaquette qubits of the respective sublattice comprises determining a quantum state of the plaquette qubit.

In an example embodiment, causing performance of the feed-forward action on the pair of plaquettes comprises causing conditional Z gates to be performed on the pair of plaquettes.

In an example embodiment, the lattice has periodic boundary conditions.

According to another aspect, a system configured for generating a ground state having non-Abelian topological order is provided. In an example embodiment, the system includes a confinement apparatus configured to confine a plurality of physical qubits; one or more manipulation sources configured to generate respective manipulation signals for interaction with respective physical qubits of the plurality of physical qubits; and a controller configured to control operation of the confinement apparatus and the one or more manipulation sources. The controller is configured to control operation of the confinement apparatus and/or the one or more manipulation sources to cause a plurality of physical qubits to be confined within a confinement apparatus. The plurality of physical qubits is logically organized onto a lattice comprising a plurality of vertices connected by edges and a plurality of plaquettes. The lattice is formed of a plurality of sublattices. Each sublattice includes a respective three or more vertices of the plurality of vertices and a respective one or more plaquettes of the plurality of plaquettes. The respective three or more vertices and the respective one or more plaquettes of a sublattice of the plurality of sublattices are connected by edges to form the sublattice. The controller is further configured to perform causing entanglement of vertex qubits of the plurality of physical qubits assigned to the respective three or more vertices of a respective sublattice in a first subset of sublattices with one or more plaquette qubits of the plurality of physical qubits assigned to the respective one or more plaquettes of the respective sublattice in the first subset of sublattices; and causing measurement of the one or more plaquette qubits assigned to the respective one or more plaquettes of the respective sublattice in the first subset of sublattices. The controller is further configured to perform causing entanglement of physical qubits of the plurality of physical qubits assigned to the respective three or more vertices of a respective sublattice in a second subset of sublattices with one or more plaquette qubits of the plurality of physical qubits assigned to the respective one or more plaquettes of the respective sublattice in the second subset of sublattices; and causing measurement of the one or more plaquette qubits of the respective sublattice in the second subset of sublattices. The controller is further configured to perform determining, based on the measurement of the one or more plaquette qubits of the respective sublattice in the first subset and the measurement of the one or more plaquette qubits of the respective sublattice in the second subset, whether any plaquettes of the plurality of sublattices are hosting an Abelian topological order; and responsive to determining that at least a pair of plaquettes of the plurality of sublattices is hosting an Abelian topological order, causing performance of a feed-forward action to be performed on the pair of plaquettes to generate the ground state having non-Abelian topological order.

In an example embodiment, the one or more plaquette qubits of each sublattice are in product state prior to the entanglement of the vertex qubits of the respective sublattice in the first subset of sublattices with the one or more plaquette qubits of the respective sublattice in the first subset of sublattices.

In an example embodiment, causing entanglement of the vertex qubits of the respective sublattice in the first subset of sublattices with the one or more plaquette qubits of the respective sublattice in the first subset of sublattices comprises causing entanglement between a particular plaquette qubit assigned to a particular plaquette of the respective one or more plaquettes and each of three vertex qubits assigned to vertices of the respective three or more vertices that are connected to the particular plaquette via edges of the sublattice and causing entanglement between another particular plaquette qubit assigned to another particular plaquette of the respective one or more plaquettes and the three vertex qubits assigned to the vertices of the respective three or more vertices that are connected to the particular plaquette via the edges of the sublattice, the three vertex qubits are also connected to the other particular plaquette via the edges of the sublattice.

In an example embodiment, causing entanglement between a particular plaquette qubit assigned to a particular plaquette of the respective one or more plaquettes and each of three vertex qubits that are each assigned to a respective vertex of the respective three or more vertices and that are connected to the particular plaquette and causing entanglement between another particular plaquette qubit assigned to another particular plaquette of the respective one or more plaquettes and the three vertex qubits that are each assigned to a respective vertex of the respective three or more vertices and that are connected to the other particular plaquette is implemented as four two-qubit gates.

In an example embodiment, the controller is further configured to perform, prior to the measurement of the one or more plaquette qubits of the respective sublattice of the first subset of sublattices, causing entanglement of the plurality of plaquettes using pairs of three operator non-Clifford interactions.

In an example embodiment, a pair of three operator non-Clifford interactions is implemented as four two-qubit gates.

In an example embodiment, the lattice is a Kagome lattice.

In an example embodiment, causing the measurement of a plaquette qubit of the one or more plaquette qubits of the respective sublattice comprises determining a quantum state of the plaquette qubit.

In an example embodiment, causing performance of the feed-forward action on the pair of plaquettes comprises causing conditional Z gates to be performed on the pair of plaquettes.

In an example embodiment, the lattice has periodic boundary conditions.

According to another aspect, a controller configured to control one or more components of a system configured for generating a ground state having non-Abelian topological order is provided. In an example embodiment, the controller includes at least one processing device and at least one memory. The at least one memory stores executable instructions configured to, when executed by the at least one processing device, cause the controller to control the one or more components of the system to cause a confinement apparatus of the system to cause a plurality of physical qubits to be confined by the confinement apparatus. The plurality of physical qubits is logically organized onto a lattice comprising a plurality of vertices connected by edges and a plurality of plaquettes. The lattice is formed of a plurality of sublattices. Each sublattice includes a respective three or more vertices of the plurality of vertices and a respective one or more plaquettes of the plurality of plaquettes. The respective three or more vertices and the respective one or more plaquettes of a sublattice of the plurality of sublattices are connected by edges to form the sublattice. The executable instructions are further configured to, when executed by the at least one processing device, cause the controller to control the one or more components of the system to cause entanglement of vertex qubits of the plurality of physical qubits assigned to the respective three or more vertices of a respective sublattice in a first subset of sublattices with one or more plaquette qubits of the plurality of physical qubits assigned to the respective one or more plaquettes of the respective sublattice in the first subset of sublattices; and causing measurement of the one or more plaquette qubits assigned to the respective one or more plaquettes of the respective sublattice in the first subset of sublattices. The executable instructions are further configured to, when executed by the at least one processing device, cause entanglement of physical qubits of the plurality of physical qubits assigned to the respective three or more vertices of a respective sublattice in a second subset of sublattices with one or more plaquette qubits of the plurality of physical qubits assigned to the respective one or more plaquettes of the respective sublattice in the second subset of sublattices; and causing measurement of the one or more plaquette qubits of the respective sublattice in the second subset of sublattices. The executable instructions are further configured to, when executed by the at least one processing device, cause the controller to determine, based on the measurement of the one or more plaquette qubits of the respective sublattice in the first subset and the measurement of the one or more plaquette qubits of the respective sublattice in the second subset, whether any plaquettes of the plurality of sublattices are hosting an Abelian topological order; and, responsive to determining that at least a pair of plaquettes of the plurality of sublattices is hosting an Abelian topological order, cause performance of a feed-forward action to be performed on the pair of plaquettes to generate the ground state having non-Abelian topological order.

In an example embodiment, the one or more plaquette qubits of each sublattice are in product state prior to the entanglement of the vertex qubits of the respective sublattice in the first subset of sublattices with the one or more plaquette qubits of the respective sublattice in the first subset of sublattices.

In an example embodiment, causing entanglement of the vertex qubits of the respective sublattice in the first subset of sublattices with the one or more plaquette qubits of the respective sublattice in the first subset of sublattices comprises causing entanglement between a particular plaquette qubit assigned to a particular plaquette of the respective one or more plaquettes and each of three vertex qubits assigned to vertices of the respective three or more vertices that are connected to the particular plaquette via edges of the sublattice and causing entanglement between another particular plaquette qubit assigned to another particular plaquette of the respective one or more plaquettes and the three vertex qubits assigned to the vertices of the respective three or more vertices that are connected to the particular plaquette via the edges of the sublattice, the three vertex qubits are also connected to the other particular plaquette via the edges of the sublattice.

In an example embodiment, causing entanglement between a particular plaquette qubit assigned to a particular plaquette of the respective one or more plaquettes and each of three vertex qubits that are each assigned to a respective vertex of the respective three or more vertices and that are connected to the particular plaquette and causing entanglement between another particular plaquette qubit assigned to another particular plaquette of the respective one or more plaquettes and the three vertex qubits that are each assigned to a respective vertex of the respective three or more vertices and that are connected to the other particular plaquette is implemented as four two-qubit gates.

In an example embodiment, the executable instructions are further configured to, when executed by the at least one processing device, cause, prior to the measurement of the one or more plaquette qubits of the respective sublattice of the first subset of sublattices, entanglement of the plurality of plaquettes using pairs of three operator non-Clifford interactions.

In an example embodiment, a pair of three operator non-Clifford interactions is implemented as four two-qubit gates.

In an example embodiment, the lattice is a Kagome lattice.

In an example embodiment, causing the measurement of a plaquette qubit of the one or more plaquette qubits of the respective sublattice comprises determining a quantum state of the plaquette qubit.

In an example embodiment, causing performance of the feed-forward action on the pair of plaquettes comprises causing conditional Z gates to be performed on the pair of plaquettes.

In an example embodiment, the lattice has periodic boundary conditions.

According to still another aspect, a computer program product is provided. The computer program product comprises at least one non-transitory memory medium storing executable instructions. The executable instructions are configured to, when executed by a processing device of a controller of a system comprising a confinement apparatus configured to confine a plurality of physical qubits, cause the plurality of physical qubits to be confined by the confinement apparatus. The plurality of physical qubits is logically organized onto a lattice comprising a plurality of vertices connected by edges and a plurality of plaquettes. The lattice is formed of a plurality of sublattices. Each sublattice includes a respective three or more vertices of the plurality of vertices and a respective one or more plaquettes of the plurality of plaquettes. The respective three or more vertices and the respective one or more plaquettes of a sublattice of the plurality of sublattices are connected by edges to form the sublattice. The executable instructions are further configured to, when executed by the processing device, cause the controller to control operation of the confinement apparatus and/or one or more manipulation sources of the system to cause entanglement of vertex qubits of the plurality of physical qubits assigned to the respective three or more vertices of a respective sublattice in a first subset of sublattices with one or more plaquette qubits of the plurality of physical qubits assigned to the respective one or more plaquettes of the respective sublattice in the first subset of sublattices; and causing measurement of the one or more plaquette qubits assigned to the respective one or more plaquettes of the respective sublattice in the first subset of sublattices. The executable instructions are further configured to, when executed by the processing device, cause the controller to control operation of the confinement apparatus and/or one or more manipulation sources of the system to cause entanglement of physical qubits of the plurality of physical qubits assigned to the respective three or more vertices of a respective sublattice in a second subset of sublattices with one or more plaquette qubits of the plurality of physical qubits assigned to the respective one or more plaquettes of the respective sublattice in the second subset of sublattices; and causing measurement of the one or more plaquette qubits of the respective sublattice in the second subset of sublattices. The executable instructions are further configured to, when executed by the at least one processing device, cause the controller to determine, based on the measurement of the one or more plaquette qubits of the respective sublattice in the first subset and the measurement of the one or more plaquette qubits of the respective sublattice in the second subset, whether any plaquettes of the plurality of sublattices are hosting an Abelian topological order; and, responsive to determining that at least a pair of plaquettes of the plurality of sublattices is hosting an Abelian topological order, cause the controller to control operation of the confinement apparatus and/or one or more manipulation sources of the system to cause performance of a feed-forward action to be performed on the pair of plaquettes to generate the ground state having non-Abelian topological order.

In an example embodiment, the one or more plaquette qubits of each sublattice are in product state prior to the entanglement of the vertex qubits of the respective sublattice in the first subset of sublattices with the one or more plaquette qubits of the respective sublattice in the first subset of sublattices.

In an example embodiment, causing entanglement of the vertex qubits of the respective sublattice in the first subset of sublattices with the one or more plaquette qubits of the respective sublattice in the first subset of sublattices comprises causing entanglement between a particular plaquette qubit assigned to a particular plaquette of the respective one or more plaquettes and each of three vertex qubits assigned to vertices of the respective three or more vertices that are connected to the particular plaquette via edges of the sublattice and causing entanglement between another particular plaquette qubit assigned to another particular plaquette of the respective one or more plaquettes and the three vertex qubits assigned to the vertices of the respective three or more vertices that are connected to the particular plaquette via the edges of the sublattice, the three vertex qubits are also connected to the other particular plaquette via the edges of the sublattice.

In an example embodiment, causing entanglement between a particular plaquette qubit assigned to a particular plaquette of the respective one or more plaquettes and each of three vertex qubits that are each assigned to a respective vertex of the respective three or more vertices and that are connected to the particular plaquette and causing entanglement between another particular plaquette qubit assigned to another particular plaquette of the respective one or more plaquettes and the three vertex qubits that are each assigned to a respective vertex of the respective three or more vertices and that are connected to the other particular plaquette is implemented as four two-qubit gates.

In an example embodiment, the executable instructions are further configured to, when executed by the processing device, cause the controller to control operation of the confinement apparatus and/or one or more manipulation sources of the system to cause, prior to the measurement of the one or more plaquette qubits of the respective sublattice of the first subset of sublattices, entanglement of the plurality of plaquettes using pairs of three operator non-Clifford interactions.

In an example embodiment, a pair of three operator non-Clifford interactions is implemented as four two-qubit gates.

In an example embodiment, the lattice is a Kagome lattice.

In an example embodiment, causing the measurement of a plaquette qubit of the one or more plaquette qubits of the respective sublattice comprises determining a quantum state of the plaquette qubit.

In an example embodiment, causing performance of the feed-forward action on the pair of plaquettes comprises causing conditional Z gates to be performed on the pair of plaquettes.

In an example embodiment, the lattice has periodic boundary conditions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system configured for generating a ground state of a non-Abelian topological order, in accordance with an example embodiment.

FIG. 2 provides a flowchart illustrating processes, procedures, and/or operations performed, by a controller of the system, for example, for generating a ground state of a non-Abelian topological order, in accordance with an example embodiment.

FIG. 3 illustrates a lattice formed of a plurality of sub-lattices and operations defined on the lattice, in accordance with an example embodiment.

FIG. 4 schematically illustrates various processes and/or procedure for generating a ground state of a non-Abelian topological order based on subsets of the plurality of sub-lattices, in accordance with an example embodiment.

FIG. 5 provides a circuit diagram illustration of a reduction of gates used to perform entanglement of physical qubits assigned to respective vertices of the vertices of a respective sublattice in a subset of the sublattices with the plaquettes of the respective sublattice, in accordance with an example embodiment.

FIG. 6 illustrates results of generating a ground state of a non-Abelian topological order, in accordance with an example embodiment.

FIG. 7 provides a schematic diagram of an example controller of a system comprising a quantum object confinement apparatus configured for confining quantum objects therein, in accordance with an example embodiment.

FIG. 8 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum objects are confined by a quantum object confinement apparatus (also referred to as a confinement apparatus herein). In various embodiments, a quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the quantum objects are ions and/or ion crystals, the confinement apparatus is an ion trap, such as a surface ion trap, Paul ion trap, and/or the like. In various other embodiments, the confinement apparatus is an apparatus configured to confine quantum objects.

In various embodiments, the quantum objects confined by a confinement apparatus are used to perform experiments, controlled quantum state evolution, quantum computations, and/or the like. In various embodiments, the quantum objects are transported between various locations at least partially defined by the confinement apparatus and/or a system comprising the confinement apparatus. For example, the confined quantum objects are physical qubits of a quantum processor including the confinement apparatus.

In various embodiments, the physical qubits are logically organized based on a lattice formed of a plurality of sublattices. In various embodiments, the sublattices are decouplable from one another, at least for some operations performed on the lattice. For example, for at least one operation defined on the lattice, the at least one operation only acts on physical qubits assigned to sites of one of a single sublattice and therefore the sublattices are decouplable with respect to the at least one operation. Thus, for portions of a circuit to be performed on the lattice that only include the at least one operation with respect to which the sublattices are decouplable, the sublattices may be treated as independent lattices. In an example embodiment, the plurality of sublattices includes three sublattices.

The lattice, in various embodiments is a Kagome lattice. A Kagome lattice is related to a trihexagonal tiling. A trihexagonal tiling is one of eleven uniform tilings of the Euclidean plane by regular polygons. A trihexagonal tiling consists of equilateral triangles and regular hexagons, arranged so that each hexagon is surrounded by triangles and vice versa. For example, two hexagons and two triangles alternate around each vertex, and its edges form an infinite arrangement of lines. The Kagome lattice consists of the vertices and edges of the trihexagonal tiling. For example, the lattice sites of the Kagome lattice are the vertices of the trihexagonal tiling, which are connected to one another by the edges of the trihexagonal tiling. In various embodiments where the lattice is a Kagome lattice, the sublattices are triangular lattices.

The term “logically organized” is used herein to indicate that the operational relationships between the plurality of physical qubits are determined based on and/or configured to conform to the lattice and the operations defined thereon. In at least one embodiment, the physical qubits of the plurality of physical qubits that form the lattice may be moved and/or transported independently of one another. Thus, the term “logically organized” is used herein to clarify that the plurality of physical qubits that form the lattice need not be physically organized based on the lattice. In particular, the interactions between the physical qubits of the lattice are governed, organized, and/or determined based on the lattice and the operations defined thereon. In various embodiments, the mobility of the physical qubits enables the arbitrary physical re-organizing of the physical qubits such that arbitrary physical qubit interactions are performable.

Complex quantum computations demand levels of precision that are not available in conventional quantum computers due to imperfect control and noise in gate operations between data qubits, for example. Proposed schemes for fault tolerant quantum computing include performing quantum computations on logical qubits that are logically organized based on a selected quantum error correction (QEC) code. Conventional quantum error correction includes the extraction of syndromes which generally includes the interaction of ancilla qubits with data qubits of a logical qubit defined by the QEC code. However, if not performed carefully, such interactions between ancilla qubits and data qubits can cause faults to spread ruinously, leading to logical errors that would have otherwise been correctable given their initial weight. Thus, technical problems exist regarding how to perform quantum computations with levels of precision that are sufficient for performing complex computations.

Various embodiments provide technical solutions to such technical problems. For example, various embodiments provide for the performance of fault tolerate quantum computing and/or fault tolerant quantum error correction using topological quantum computing. Topological quantum computing uses a phase of matter referred to as topological order to perform quantum computations. Topological order is a manifestation of long-range quantum entanglement of a plurality of quantum objects, such as the physical qubits. For example, a concentration of entanglement of the underlaying physical qubits forms a quasiparticle referred to as an anyon. For example, anyons are excitations of topological order (e.g., similar to how phonons are excitations of motional modes of matter).

Various embodiments provide for the preparation and/or generation of a ground state of non-Abelian topological order. Non-Abelian topological order is a type of typological order having non-Abelian (e.g., non-commutative) properties. A result of the non-Abelian nature of such a state of matter results in the non-Abelian anyons “remembering” their respective histories. For example, performing Operation A and then performing Operation B on a non-Abelian anyon will provide a different result than performing Operation B and then performing Operation A on the non-Abelian anyon due to the non-commutativity of the non-Abelian topological order. It is expected that these features of non-Abelian topological order will enable performance of fault tolerant quantum computing using non-Abelian anyons and/or various states of non-Abelian topological order.

Classical simulations are not able to simulate systems and/or matter exhibiting non-Abelian topological order. Therefore, in order to test whether these expectations of fault tolerant computing using non-Abelian topological order will come to bear, states of non-Abelian topological order must be generated and empirically investigated. However, conventional and experimentally successful techniques for the preparation and/or generation of states of non-Abelian topological order are not present in the art. Therefore, technical problems exist regarding the preparation and/or generation of states of non-Abelian topological order. Moreover, technical problems exist regarding to determining whether and/or how topologically-protected quantum computing can provide for higher precision quantum computations.

Various embodiments provide technical solutions to these technical problems. For example, various embodiments provide methods, systems, controllers for systems, computer program products for configuring controllers of systems for preparing and/or generating states of a non-Abelian topological order. For example, in various embodiments, a ground state of non-Abelian topological order may be generated using a plurality of physical qubits of a quantum processor, such as a QCCD-based processor. The non-Abelian topological order may then be manipulated and/or interacted with to provide various excited states and/or various (other) ground states of the non-Abelian topological order.

For example, due to the limited number of physical qubits available to conventional quantum processors (e.g., generally less than 50), various embodiments implement methods for generating a ground state of a non-Abelian topological order that use reduced number of physical qubits. For example, conventional theoretical techniques for generating a ground state of non-Abelian topological order may require the use of more physical qubits than are available to a conventional quantum processor. Various embodiments reduce the number of physical qubits required to prepare and/or generate the ground state of non-Abelian topological order by performing a sequence of entanglement and measurement operations on a first subset of the sublattices and then re-initializing and re-using one or more of the physical qubits used to perform the sequence of entanglement and measurement operations on the first subset of the sublattices to perform a sequence of entanglement and measurement operations on a second subset of the sublattices. In some embodiments, more than two subsets of sublattices are used (e.g., three or more subsets of sublattices, where the maximum number of subsets of sublattices is set by the number of sublattices such that none of the subsets of sublattices are empty and the intersection of each pair of subsets of sublattices is empty).

In another example, various embodiments reduce the number of gates performed to prepare and/or generate a ground state of a non-Abelian topological order such that the depth and the length of time needed to perform a quantum circuit that prepares and/or generates the ground state of the non-Abelian topological order is reduced. For example, physical qubits have a finite coherence time. Therefore, having a very deep quantum circuit (e.g., quantum circuit including a large number of gates) may negatively affect the fidelity with which the ground state of the non-Abelian topological order may be prepared and/or generated. For example, a conventional theoretical technique for generating a ground state of non-Abelian topological order includes performance of 108 two-qubit gates. However, according to an example embodiment, the ground state of non-Abelian topological order is generated using only 78 two-qubit gates.

Therefore, various embodiments provide technical solutions to the technical problems regarding the preparation and generation of a ground state of non-Abelian topological order. Various embodiments therefore provide technical improvements to the fields of fault tolerant and/or topologically-protected quantum computing.

### Example System Configured for Generating States of Non-Abelian Topological Order

Various embodiments provide systems that are configured for generating states of non-Abelian topological order (e.g., one or more ground states which may be manipulated and/or interacted with to yield one or more excited states, and/or the like). In various embodiments, the system includes a plurality of physical qubits. For example, in various embodiments, the system includes a confinement apparatus that confines a plurality of quantum objects that are used as the physical qubits. For example, in various embodiments the system is a QCCD-based quantum computing system, such as a QCCD-based processor, and/or the like. These systems may be configured for use in performing fault tolerant and/or topologically-protected quantum computing, and/or the like. In various embodiments, the system is configured for creating and/or making use of non-abelian topological order and anyons. An example QCCD-based quantum computing system will now be disclosed.

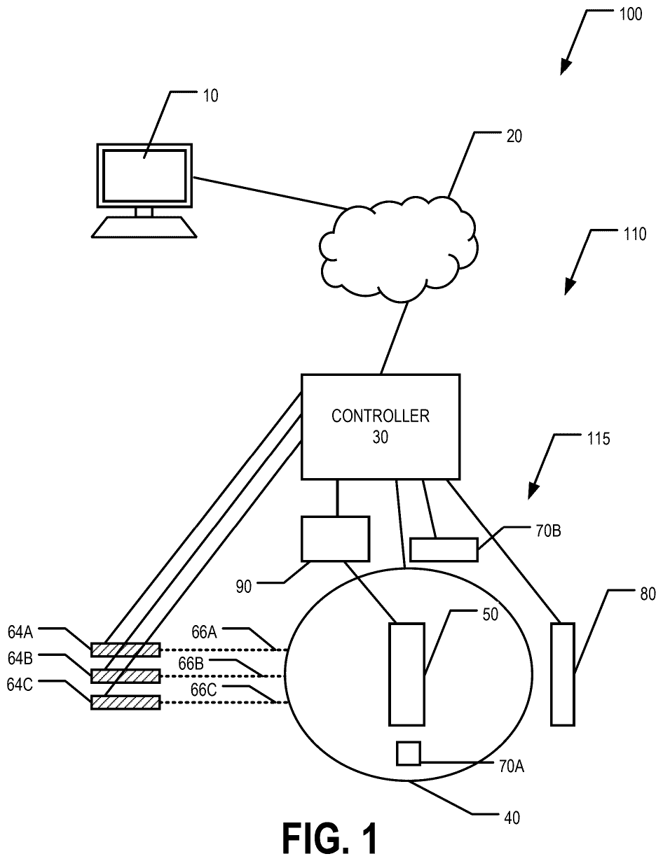

Various embodiments provide a system 100 comprising a quantum object confinement apparatus 50 (also referred to herein as a confinement operation), as shown in FIG. 1. The confinement apparatus 50 is configured to confine a plurality of quantum objects such that the respective quantum states of the quantum objects may be manipulated, evolved in a controlled manner (e.g., in accordance with a quantum circuit), and/or the like.

For example, quantum operation functions (one qubit quantum gates, two-qubit quantum gates, initialization, reading and/or measurement operations, and/or the like) may be performed on quantum objects disposed within quantum operation locations defined by the confinement apparatus 50 and/or system 100 comprising the confinement apparatus. For example, the confinement apparatus 50 is configured to maintain one or more quantum objects at a quantum operation location such that the quantum operation may be performed on the one or more quantum objects. For example, the quantum objects confined by the confinement apparatus 50 are used as the physical qubits of the system 100.

In various embodiments, the system 100 comprising the confinement apparatus 50 comprises one or more manipulation sources 64 (e.g., 64A, 64B, 64C) configured to provide manipulation signals (e.g., laser beams and/or pulses, microwave signals, and/or the like) such that the manipulation signals interact with one or more quantum objects disposed at respective quantum operation locations. In various embodiments, the system 100 comprising the confinement apparatus 50 comprises one or more magnetic field sources 70 (e.g., 70A, 70B) configured to provide a controlled magnetic field and/or magnetic field gradient at quantum operation locations for use in performing one or more quantum operations on one or more quantum objects disposed at the quantum operation locations. In various embodiments, the system 100 comprising the confinement apparatus 50 comprises an optical collection system 80 configured to collect and/or detect light and/or photons emitted (e.g., fluoresced) by one or more quantum objects disposed at respective quantum operation locations.

In an example embodiment, the system 100 comprising the confinement apparatus 50 is and/or includes a quantum charge-coupled device (QCCD)-based quantum computer. For example, one or more of the quantum objects confined by the confinement apparatus 50 may be used as physical qubits of the quantum computer.

In various embodiments, the system 100 comprises a computing entity 10 and a quantum computer 110. In various embodiments, the quantum computer 110 comprises a controller 30 and a quantum processor 115. In various embodiment, the quantum processor 115 comprises a cryostat and/or vacuum chamber 40 enclosing a confinement apparatus 50, one or more manipulation sources 64 (e.g., 64A, 64B, 64C), one or more voltage sources 90, one or more magnetic field sources 70 (e.g., 70A, 70B), an optical collection system 80, and/or the like. In various embodiments, the controller 30 is configured to control the operation of (e.g., control one or more drivers configured to cause operation of) the manipulation sources 64, voltage sources 90, magnetic field sources 70, a vacuum system and/or cryogenic cooling system (not shown), and/or the like. In various embodiments, the controller 30 is configured to receive signals (e.g., electrical signals) generated and provided by the optical collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects confined by the confinement apparatus 50. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/measurement, and/or like) on quantum objects confined by the confinement apparatus 50.

In an example embodiment, the one or more manipulation sources 64 each provide a manipulation signal (e.g., laser beam and/or the like) to one or more portions (e.g., quantum operation locations) of the confinement apparatus 50 via corresponding beam path systems 66 (e.g., 66A, 66B, 66C). In various embodiments, at least one beam path system 66 comprises a modulator configured to modulate the manipulation signal being provided to the confinement apparatus 50 via the beam path system 66. In various embodiments, the manipulation sources 64, active components of the beam path systems 66 (e.g., modulators and/or the like), and/or other components of the quantum computer 110 are controlled by the controller 30.

In various embodiments, the confinement apparatus 50 is an ion trap, such as a surface ion trap, Paul ion trap, and/or the like. In various embodiments, the quantum objects are ions; atoms; ion crystals and/or groups; atomic crystals and/or groups; ionic, molecular, and/or multipolar molecules; quantum dots; quantum particles; groups, crystals, and/or combinations thereof (e.g., ion crystals); and/or the like. In various embodiments, the confinement apparatus 50 is an appropriate confinement apparatus for confining the quantum objects of the embodiment. In various embodiments, the confinement apparatus 50 is similar to the confinement apparatuses and/or ion traps disclosed in U.S. application Ser. No. 17/810,082, filed Jun. 30, 2022, U.S. Pat. No. 11,037,776, issued Jun. 15, 2021, U.S. application Ser. No. 17/533,587, filed Nov. 23, 2021, and/or U.S. Application No. 63/500,710, filed May 8, 2023.

In various embodiments, the quantum computer 110 comprises one or more voltage sources 90. For example, the voltage sources may be arbitrary wave generators (AWG), digital-analog converts (DACs), direct digital synthesizers (DDSs), and/or other voltage signal generators. For example, the voltage sources 90 may comprise a plurality of control voltage drivers and/or voltage sources and/or at least one RF driver and/or voltage source. The voltage sources 90 may be electrically coupled to the corresponding potential generating elements (e.g., control electrodes and/or RF electrodes) of the confinement apparatus 50, in an example embodiment.

In various embodiments, the voltage signals generated by the voltage sources 90 are filtered before being applied to the potential generating elements (e.g., control electrodes and/or RF electrodes) of the confinement apparatus 50. In an example embodiment, the system 100 comprises filters configured to filter the voltage signals generated by the voltage sources 90 and applied to the electrodes of the confinement apparatus 50.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more locations defined by the confinement apparatus 50 that has a particular magnitude and a particular magnetic field direction in the one or more locations defined by the confinement apparatus 50.

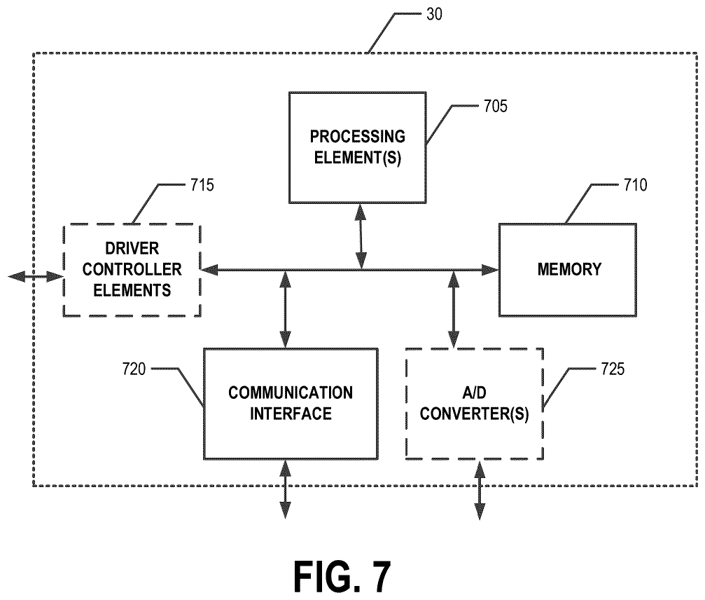

In various embodiments, the quantum computer 110 comprises an optical collection system 80 configured to collect and/or detect photons (e.g., stimulated emission) generated by quantum objects disposed in respective quantum operation locations (e.g., during reading/measurement operations). The optical collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the quantum objects. In various embodiments, the detectors may be in electronic communication with the controller 30 via one or more A/D converters 725 (see FIG. 7) and/or the like.

In various embodiments, a computing entity 10 is configured to allow a user to provide input to the quantum computer 110 (e.g., via a user interface of the computing entity 10) and receive, view, and/or the like output from the quantum computer 110. For example, a user may operate a (classical and/or semiconductor-based) computing entity 10 to generate a quantum program and/or circuit and the computing entity 10 may provide the quantum program and/or circuit and/or a compiled version thereof to the controller 30 of the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 90, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus 50, and/or read and/or measure a quantum (e.g., qubit) state of one or more quantum objects within the confinement apparatus. For example, the controller 30 may cause a controlled evolution of quantum states of one or more quantum objects confined by the confinement apparatus 50 to execute a quantum circuit and/or algorithm. For example, the controller 30 may cause entanglement of one or more quantum objects confined by the confinement apparatus 50 to prepare and/or generate a ground state or excited state of a non-Abelian topological order. For example, the controller 30 may read and/or detect quantum states of one or more quantum objects within the confinement apparatus 50 at one or more points during the execution of a quantum circuit. In various embodiments, the quantum objects confined by the confinement apparatus are used as qubits of the quantum computer 110.

Example Preparation and/or Generation of a Ground State of a Non-Abelian Topological Order

In various embodiments, a lattice is defined that includes a plurality of vertices that are connected by respective edges. In an example embodiment, the lattice is a Kagome lattice. Physical qubits of the quantum processor 115 are assigned to respective vertices of the lattice so as to logically organize the physical qubits based on the lattice. The vertices of the lattice are colored so as to define a plurality of sublattices that are decouplable with respect to at least one operation defined on the lattice. For example, in an example embodiment, the lattice is colored with three colors.

In various embodiments, the lattice defines a plurality of plaquettes. In general, a plaquette is the smallest closed loop, enclosing the region between four lattice sites. For example, when the lattice is a Kagome lattice, the physical qubit assigned the lattice site at the center of a hexagon of the lattice represents a plaquette of the lattice. Each of the plaquettes are initiated into a product state. A product state is a multi-qubit state that can be expressed as a simple combination of various independent states of multiple single-qubit systems. For example, a product state is a multi-qubit state that can be decomposed into the tensor product of individual qubit states.

The vertex qubits (e.g., physical qubits assigned to respective vertices) of a first sublattice are entangled with the plaquettes (e.g., the physical qubits representing the plaquettes) of the first sublattice. The first sublattice is a member of a first subset of sublattices of the lattice. In various embodiments, the vertex qubits (e.g., physical qubits assigned to respective vertices) of a respective sublattice of the first subset of sublattices are entangled with the plaquettes (e.g., the physical qubits representing the plaquettes) of the respective sublattice. In an example embodiment, for each sublattice of the first subset of sublattices the vertex qubits (e.g., physical qubits assigned to respective vertices) of the sublattice of the first subset of sublattices are entangled with the plaquettes (e.g., the physical qubits representing the plaquettes) of the same sublattice. The qubits representing the plaquettes may then be entangled using pairs of three-operator non-Clifford interactions. The three-operator non-Clifford interactions act on each of the sublattices (e.g., the sublattices of both the first subset and the second subset of sublattices). The plaquettes of the sublattices of the first subset of sublattices are then measured.

In various embodiments, after measurement of the plaquettes of the sublattices of the first subset of sublattices(e.g., after performing measurement operations on the physical qubits assigned to the plaquettes of the sublattices of the first subset of sublattices), some of the physical qubits assigned to plaquettes of the sublattices of the first subset of sublattices may be re-initialized (e.g., their quantum state may be set back to a known initial quantum state such as |0>, for example) and re-assigned to respective vertices of a sublattice of the second subset of sublattices and/or used as ancilla qubits.

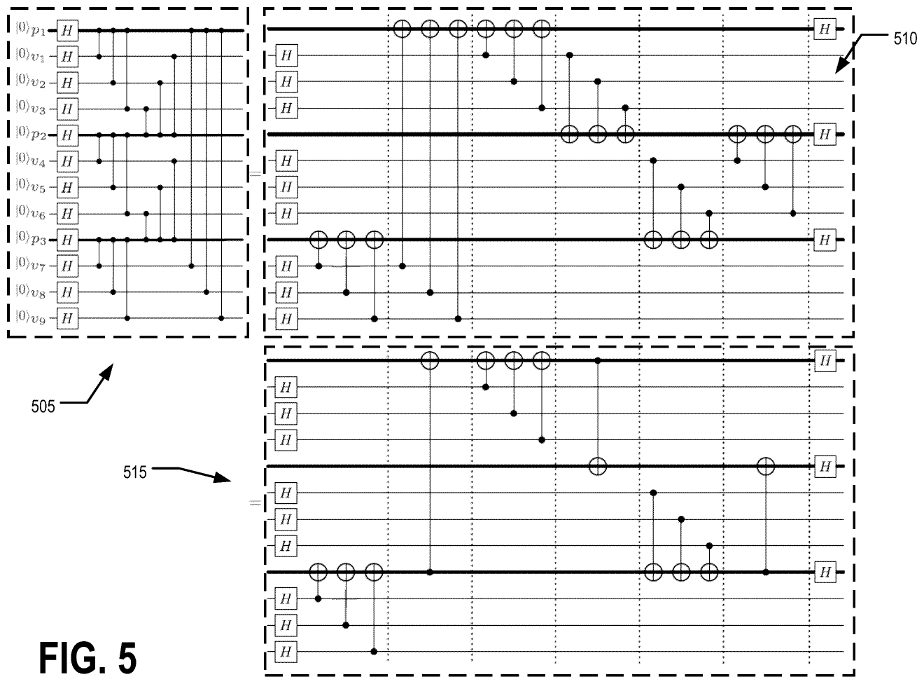

In various embodiments, the first subset of sublattices and the second subset of sublattices do not overlap. In other words, the intersection of the first subset of sublattices with the second subset of sublattices is empty. In the embodiment illustrated in FIG. 5, the first subset of sublattices includes the green sublattice and the blue sublattice (e.g., sublattices colored by a first color and a second color) and the second subset of sublattices includes the red sublattice (e.g., the remaining sublattice colored by a third color).

In various embodiments, the vertex qubits (e.g., physical qubits assigned to respective vertices) of a respective sublattice of the second subset of sublattices are entangled with the plaquettes (e.g., the physical qubits representing the plaquettes) of the respective sublattice. In an example embodiment, for each sublattice of the second subset of sublattices the vertex qubits (e.g., physical qubits assigned to respective vertices) of the sublattice of the second subset of sublattices are entangled with the plaquettes (e.g., the physical qubits representing the plaquettes) of the same sublattice. The qubits representing the plaquettes may then be entangled using pairs of three-operator non-Clifford interactions. The plaquettes of the sublattices of the second subset of sublattices are then measured.

Based on the measurements of the plaquettes, it is determined whether any of the plaquettes are hosting Abelian anyons. For example, the entanglement of the physical qubits results in a topological order and the measurements may provide an indication of, for each plaquette, whether the topological order present at that plaquette is Abelian or non-Abelian. For example, plaquette's hosting Abelian anyons and/or having Abelian topological order present thereat are identified.

A feed forward action is performed on the plaquettes determined to be hosting Abelian anyons and/or having Abelian topological order present thereat to cause the topological order present at those plaquettes to be non-Abelian. In various embodiments, the feed forward action is performed on one or more pairs of plaquettes determined to be hosting Abelian anyons and/or having Abelian topological order present thereat. In an example embodiment, the plaquettes of a pair of plaquettes are of the same sublattice. In an example embodiment, performing the feed forward action on a pair of plaquettes includes performing a controlled Z gate on the pair of plaquettes. In an example embodiment, the resulting ground state of the non-Abelian topological order is a D₄ topological order.

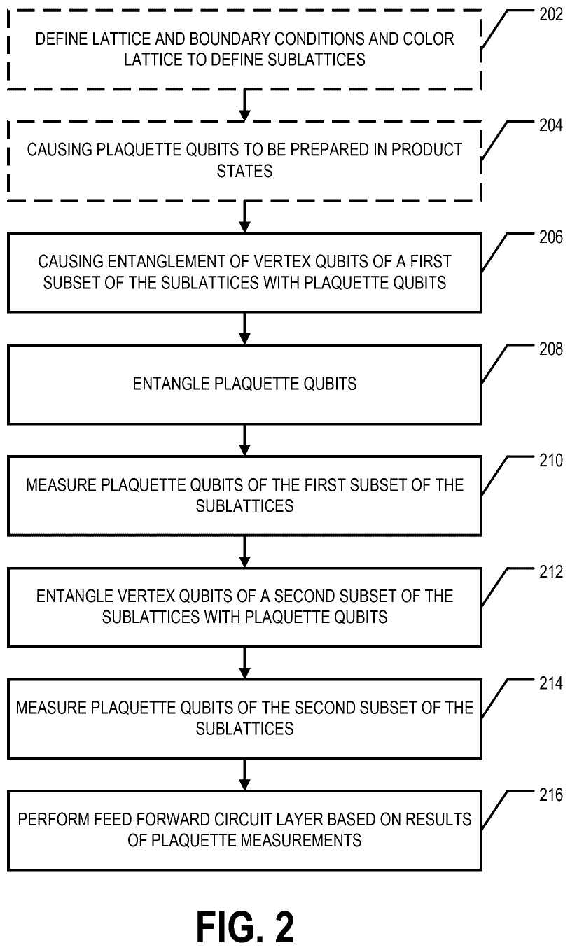

FIG. 2 provides a flowchart illustrating various processes, procedures, and/or the like performed by a controller 30 to cause preparation and/or generation of a non-Abelian topological order using the physical qubits of the quantum processor 115.

Starting at step 202, a lattice is defined. In various embodiments, the lattice is a Kagome lattice. In various embodiments, boundary conditions of the lattice are defined. For example, in various embodiments, the lattice has periodic boundary conditions. For example, the lattice may be formed on a torus. For example, the lattice may be a two-dimensional lattice housed and/or formed on a toroidal manifold.

In various embodiments, the lattice may be colored so as to define a set of sublattices. For example, a color may be assigned to each site of the lattice (e.g., to each vertex and each plaquette of the lattice). In various embodiments, the intersection of each sublattices with each of the other sublattices is empty and the union of all of the sublattices is the lattice. In an example embodiment, the lattice is colored with three colors such that three sublattices are defined. In various other embodiments fewer or more colors may be used and/or fewer or more sublattices may be defined. In an example embodiment where the lattice is a Kagome lattice, each of the sublattices is a triangular lattice.

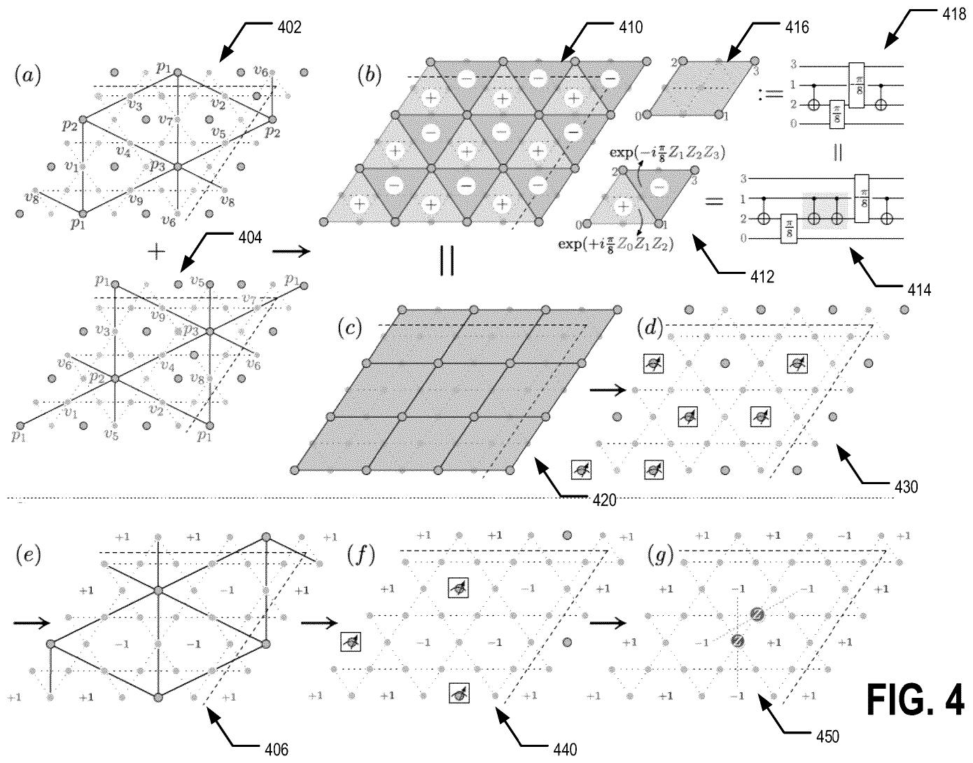

In an example embodiment, a first subset of the sublattices and a second subset of the sublattices are defined. For example, in the embodiment illustrated in FIG. 4, the first subset of sublattices includes a first sublattice of a first color (e.g., blue) and a second sublattice of a second color (e.g., green) and the second subset of sublattices includes a third sublattice of a third color (e.g., red). In various embodiments, the intersection of the first subset of sublattices with the second subset of sublattices is empty and the union of the subsets of sublattices (e.g., the union of the first subset and the second subset when there are only two subsets) is the lattice. In various embodiments, two or more non-empty subsets of sublattices may be defined.

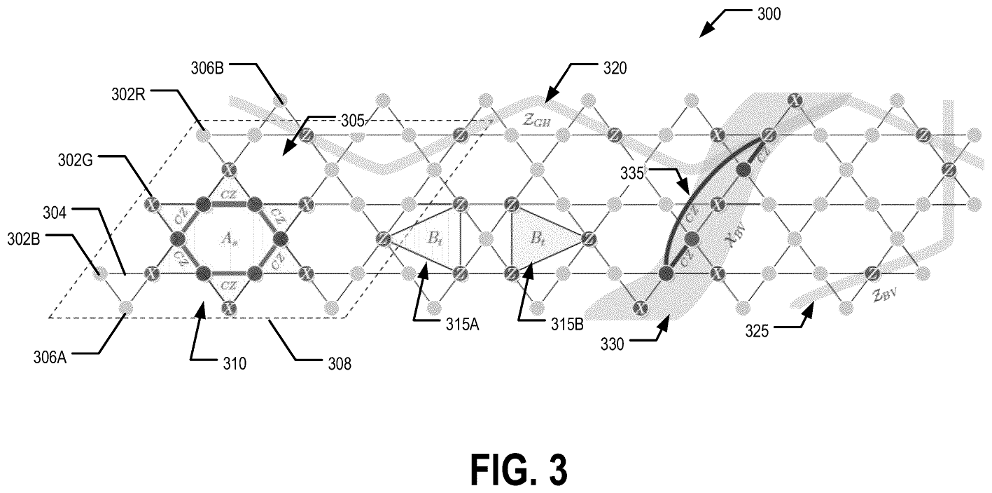

FIG. 3 illustrates an example lattice 300 comprising a plurality of lattice sites 302 that have been colored with a first color (e.g., blue site 302B), a second color (e.g., green site 302G), and a third color (e.g., red site 302R). The lattice sites 302 are connected by edges 304 so as to define the lattice. Each edge 304 connects two lattice sites 302 having different colors. Two lattice sites 302 that are the end points of a particular edge 304 are said to be directly connected to one another via the lattice. In various embodiments, the lattice has periodic boundary conditions such that in an example scenario where the portion of the lattice enclosed by the dashed line 308 is implemented, such that when the lattice is folded to make the boundaries meet, a boundary site 306A aligns and/or overlaps with boundary site 306B, for example. In other words, the boundary site 306A is connected (e.g., via edges 304 of the lattice) with the blue site and the green site that boundary site 306B is connected to, as a result of the periodic boundary conditions.

As shown in FIG. 3, various operations are defined on the lattice 300. Each plaquette supports one star operator 310 and two triangle operators 315A, 315B. For example, star operator 310 is an operator that works on twelve sites. As illustrated, the star operator 310 enacts operator A_{S}=Πᵢ₌₁⁶ CZ_{i,i+1l X}^{⊗6}, CZ_{i,i+1} is a controlled Z-gate between adjacent sites around the hexagon of the particular star and X^{⊗6} is the product of X-gates (e.g., Pauli-X gates) performed on each of the six points of the particular star (e.g., X₁⊗X₂⊗X₃⊗X₄⊗X₅⊗X₆). A single instance of a star operator 310 acts on lattice sites of multiple colors (e.g., all three of the first color, second color, and third color, in the illustrated embodiment). A triangle operator 315 may point in either direction across the hexagon of a plaquette. Thus, while a plaquette supports one star operator 310, each plaquette supports two triangle operators 315. The three-site triangle operator 315 enacts operator B_{T}=Z^{⊗3}=Z₁⊗Z₂⊗Z₃ or the product of Z-gates performed on the three sites acted upon by the triangle operator 315. A single instance of the triangle operator 315 acts on lattice sites of a single color. As a result, the sublattices are decouplable with respect to the triangle operator 315.

The Hamiltonian of qubits arranged on a periodic Kagome lattice giving rise to non-Abelian topological order is H=−Σ_{Sϵ{⋆}}A_{S}− [symbol] B_{T}, where {⋆} is the set of stars on the periodic Kagome lattice and { [symbol] >} is the set of (left-facing and right-facing)triangles on the periodic Kagome lattice. A ground state of the non-Abelian order satisfies A_{S}=B_{T}=1.

Additionally, for each color of the lattice and each direction (e.g., vertical, horizontal) along the torus, two logical string operators are defined. The logical Z-operators are products of local Pauli-Z gates acting on all the lattice sites (e.g., the physical qubits assigned to the lattice sites) of a respective color in a chosen direction. For example, FIG. 3 illustrates the logical horizontal green Z-operator Z_{GH} and the logical vertical blue Z-operator Z_{BV}. The logical X-operators, of which the logical vertical blue X-operator λ_{BV} is shown in FIG. 3, is a product of local Pauli-X gates with a series of controlled Z gates that connect every green vertex with preceding red vertices on the path in the chosen direction.

Continuing with FIG. 2, at step 204, the plaquettes are prepared in product states. For example, the controller 30 assigns physical qubits to each of the plaquettes and to the vertices of at least the sublattices of a first subset of the sublattices. Notably, the physical qubits are logically organized onto the plaquettes and vertices of the lattice and need not be physically organized within the confinement apparatus to physically form the lattice. In other words, the lattice defines functional and/or operational relationships between the physical qubits, rather than physical relationships of the physical qubits.

In various embodiments, a physical qubit is assigned to each of the plaquettes. For example, respective physical qubits are assigned to each of the plaquettes of each of the sublattices (including the sublattices of a first subset of sublattices and the sublattices of a second subset of sublattices). Additionally, physical qubits are assigned to the vertices of the sublattices of the first subset of sublattices.

Each of the physical qubits assigned to plaquettes are prepared in product states. A product state is a multi-qubit state that can be expressed as a simple combination of various independent states of multiple single-qubit systems. For example, a product state is a multi-qubit state that can be decomposed into the tensor product of individual qubit states. For example, the plaquettes may be prepared and/or initialized into a |+ [symbol] ^{⊗N}^{_{P}} product state, where N_{P} is the number of plaquettes. For example, preparing and/or initializing the plaquettes into the product state includes performing a sequence of single qubit gates on respective physical qubits to cause the respective physical qubits to be in and/or to initialize the respective physical qubits into respective |+ [symbol] states. For example, the controller 30 controls operation of at least the confinement apparatus 50 and the manipulation sources 64 to perform single qubit gates on the physical qubits to prepare the plaquettes in the product state (e.g., a |+ [symbol] ^{⊗N}^{_{P}} product state).

In various embodiments, the physical qubits assigned to the vertices of the sublattice(s) of the first subset of sublattices are prepared in a known initial state. For example, in an example embodiment, each of the physical qubits assigned to a vertex of a sublattice of the first subset of sublattices is prepared in a known initial state, such as |0>.

At step 206, the controller causes entangle of vertex qubits of a first subset of the sublattices with the plaquette qubits. In an example embodiment illustrated in FIG. 4, the first subset of sublattices includes the first sublattice (e.g., the blue sublattice) and the second sublattice (e.g., the green sublattice). For each sublattice of the first subset of sublattices, vertices of the sublattice are entangled with the plaquettes of the sublattice. In various embodiments, a vertex of the sublattice is entangled with the plaquettes of the sublattice that are (directly) connected to the vertex of the sublattice via the edges of the sublattice.

For example, as shown in panel 402 of FIG. 4, for a first sublattice (e.g., the blue sublattice) physical qubits assigned to the vertices of the first sublattice (e.g., v₁-v₉). Physical qubits are also assigned to the plaquettes of the first sublattice (e.g., p₁-p₃). The physical qubits assigned to the plaquettes of the first sublattice (also referred to herein as the first plaquette qubits) are entangled with physical qubits assigned to the vertices of the first sublattice (also referred to herein as the first vertex qubits) via an entangling gate. In an example embodiment, the entangling gate is a controlled NOT gate (e.g., a CNOT gate). In another example embodiment, the entangling gate is a controlled Z gate (e.g., a CZ gate). For example, as shown in panel 402 of FIG. 4, first plaquette qubit p₁ is linked and/or directly connected to first vertex qubits v₁, v₂, v₃, v₇, v₈, and v₉ via respective edges of the first sublattice. Thus, as shown in FIG. 5, entangling gates are performed between the first plaquette qubit and each of the first vertex qubits v₁, v₂, v₃, v₇, v₈, and v₉.

FIG. 5 shows a condensed notation circuit 505 that illustrates, after performance of a single qubit Hadamard gate on each of the first plaquette qubits and each of the first vertex qubits, performance of entangling gates between the first plaquette qubit and each of the first vertex qubits v₁, v₂, v₃, v₇, v₈, and v₉; performance of entangling gates between the second plaquette qubit and each of the first vertex qubits (directly) connected thereto via respective edges of the first sublattice (e.g., the first vertex qubits v₁, v₂, v₃, v₄, v₅, and v₆); and performance of entangling gates between the third plaquette qubit and each of the first vertex qubits (directly) connected thereto via respective edges of the first sublattice (e.g., the first vertex qubits the first vertex qubits v₄, v₅, v₆, v₇, v₈, and v₉).

FIG. 5 also shows expanded notation circuit 510 which is equivalent to the condensed notation circuit 505. Moreover, due to the fact that each of the plaquette qubits (including the first plaquette qubits) were prepared in a product state (e.g., the |+> product state) and each of the first vertex qubits were prepared in a known initial quantum state (e.g., the |0> single qubit state), performance of the set of entangling gates between the first plaquette qubit p₁ and the first vertex qubits v₁, v₂, v₃, v₇, v₈, and v₉ is equivalent to performance of entangling gates between the first plaquette qubit p₁ with the first vertex qubit v₁, v₂, and v₃ and an entangling gate between the first plaquette qubit p₁ and the first plaquette qubit p₃ (the other first plaquette qubit (directly) connected to first vertex qubits v₇, v₈, and v₉ via the edges of the sublattice). This is shown in the reduced circuit 515 of FIG. 5. Thus, instead of performing six two-qubit gates for each plaquette of the sublattice to entangle the first vertex qubits with the first plaquette qubits, only four two-qubit gates need be performed for each plaquette of the sublattice. For each sublattice, this results in a reduction of six fewer two-qubit gates per sublattice.

In an example embodiment, the first subset of sublattices includes a second sublattice (e.g., a green sublattice). In such embodiments, the physical qubits assigned to the vertices of the second sublattice (which is a member of the first subset of sublattices) are entangled with the physical qubits assigned to the plaquettes of the second sublattice. The physical qubits assigned to the plaquettes of the second sublattice (also referred to herein as the second plaquette qubits) are entangled with physical qubits assigned to the vertices of the second sublattice (also referred to herein as the second vertex qubits) via an entangling gate. In an example embodiment, the entangling gate is a controlled NOT gate (e.g., a CNOT gate). In another example embodiment, the entangling gate is a controlled Z gate (e.g., a CZ gate). For example, as shown in panel 404 of FIG. 4, second plaquette qubit p₁ is linked and/or directly connected to second vertex qubits v₁, v₂, v₃, v₇, v₈, and v₉ via respective edges of the second sublattice; second plaquette qubit p₂ is linked and/or directly connected to second vertex qubits v₁, v₂, v₃, v₄, v₅, and v₆ via respective edges of the second sublattice; and second plaquette qubit p₃ is linked and/or directly connected to second vertex qubits v₄, v₅, v₆, v₇, v₈, and v₉ via respective edges of the second sublattice. Entangling gates are performed, in various embodiments, to entangle the second plaquette qubits with the second vertex qubits linked and/or directly connected thereto (e.g., via edges of the second sublattice). In various embodiments, the entangling gates may be performed in accordance with the condensed notation circuit 505/expanded notation circuit 510 or in accordance with the reduced circuit 515. For example, when the entangling of the second plaquette qubits with the second vertex qubits is performed in accordance with the reduced circuit 515, instead of performing six two-qubit gates for each plaquette of the second sublattice to entangle the second vertex qubits with the second plaquette qubits, only four two-qubit gates need be performed for each plaquette of the second sublattice.

In various embodiments, entangling of two physical qubits is performed by transporting the physical qubits into proximity with one another and causing an interaction between the two physical qubits. For example, in an example embodiment where the physical qubits are ions confined within a confinement apparatus such as a surface ion trap, the voltage sources 90 configured to generate and provide voltage signals for application to the electrodes of the surface ion trap are operated to generate and provide voltage signals that cause the two physical qubits to be transported to a common location and to be disposed within a common potential well. One or more manipulation sources 64 are operated to generate and provide respective manipulation signals such that the manipulation signals are incident on the two physical qubits to cause the interaction between the two physical qubits that results in the performance of the entangling gate. In various embodiments, the manipulation signals may be laser beams/pulses, microwave fields/pulses, a magnetic field gradient, and/or the like. After performance of the entangling gate, the two physical qubits may be transported away from one another.

For example, the controller 30 may control operation of the confinement apparatus 50 (e.g., via controlling operation of the voltage sources 90 that generate and provide voltage signals for application to the electrodes of the confinement apparatus, in an example embodiment) and the manipulation sources 64 to cause performance of entangling gates on two physical qubits in accordance with the condensed notation circuit 505/expanded notation circuit 510 or in accordance with the reduced circuit 515 for each sublattice of the first subset of sublattices.

Returning to FIG. 2, at step 208, the controller 30 causes entanglement of the plaquette qubits of the lattice. For example, in various embodiments, the plaquettes are entangled with one another via three operator non-Clifford interactions. In an example embodiment, the number of operators in the non-Clifford interactions may be selected based on the geometry of the lattice and/or the number of sublattices that form the lattice.

For example, as shown in panel 410 of FIG. 4, on each triangle of plaquette qubits, comprising a plaquette of each sublattice, a three operator non-Clifford interaction is performed. In various embodiments, the three operator non-Clifford interaction is of the form exp(±i π/8Z_{B}Z_{R}Z_{G}) where Zᵢ is a Z gate (e.g., a Pauli-Z) performed on the ith plaquette of the triangle of plaquette qubits (e.g., the blue plaquette, red plaquette, or green plaquette of the triangle of plaquette qubits), as shown in panel 412 of FIG. 4. When two triangles of plaquette qubits are considered, the three operator non-Clifford interactions thereon may be performed as shown in circuit portion 414.

In various embodiments, the entangling of two triangles of plaquette qubits is performed as the entangling of a parallelogram of plaquette qubits, as shown in panel 416. As shown by circuit portion 418, entangling of a parallelogram of plaquette qubits is performed using four two-qubit gates. Performance of the circuit portion 418 has the same effect as the performance of the circuit portion 414 but requires two fewer two-qubit gates. For example, in an example embodiment, a circuit portion 418 is performed for each of the nine parallelograms shown in panel 420. Thus, entangling of the plaquette qubits using the circuit portion 418 results in an 18 two-qubit gate reduction in the number of two-qubit gates required for preparing the ground state of the non-Abelian topological order, compared to when the circuit portion 414 is used.

As described above, in various embodiments, the controller 30 controls operation of the confinement apparatus (e.g., via controlling operation of the voltage sources 90 that generate and provide voltage signals for application to the electrodes of the confinement apparatus, in an example embodiment) and the manipulation sources 64 to cause two physical qubits to be gated together to be transported into proximity with one another (e.g., into a common potential well that confines both of the two qubits) and causes one or more manipulation signals to be incident on the two qubits to enact the two-qubit gate. For example, the controller 30 may control operation of the confinement apparatus 50 and the manipulation signals to cause appropriate pairs of physical qubits to be transported into proximity with one another and to cause appropriate manipulation signals to be incident thereon to enact two-qubit gates in accordance with a sequence of circuit portions 418, for example.

Continuing with FIG. 2, at step 210, the controller causes the plaquette qubits of the sublattice(s) of the first subset of sublattices to be measured. For example, in the illustrated example where the first subset of sublattices includes the first sublattice (e.g., the blue sublattice) and the second sublattice (e.g., the green sublattice), the first plaquette qubits and the second plaquette qubits are measured. For example, respective qubit states of each of the plaquette qubits of the sublattices that are members of the first subset of sublattices are determined by performing measurement operations thereon. In an example embodiment, the measurement of the plaquette qubits is performed in the X-basis, resulting in a state determination of |+> (e.g., a measurement result of +1) or |−> (e.g., a measurement result of −1). In an example embodiment, to perform the measurement of the plaquette qubits in the X-basis, a single qubit Hadamard gate is performed on the qubit prior to performance of the measurement operation. For example, panel 430 of FIG. 4 illustrates the measurement of the plaquette qubits of the sublattices of the first subset of sublattices.

In various embodiments, performing a measurement operation on a physical qubit (e.g., a physical qubit of a QCCD-based quantum processor 115) includes causing a reading manipulation signal that is resonant or near resonant with a particular transition of the physical qubit to be incident on the physical qubit. When the wavefunction of the physical qubit collapses to a first qubit state of the physical qubit, the qubit will fluoresce in response to the reading manipulation signal being incident thereon and when the wavefunction of the physical qubit collapses to a second qubit state of the physical qubit, the qubit will not fluoresce in response to the reading manipulation signal being incident thereon. The optical collection system 80 detects and/or captures any fluorescence generated in response to the reading manipulation signal being incident on the physical qubit. The optical collection system 80 provides sensor signals to the controller 30 (e.g., via A/D converter 725). The controller 30 processes the sensor signals to determine to which qubit state the wavefunction of the physical qubit collapsed.

In various embodiments, after measurement of the plaquette qubits of the sublattices of the first subset of sublattices, some of the physical qubits previously assigned to plaquettes of one or more of the sublattices of the first subset of sublattices are re-initialized (e.g., to the known initial state such as |0>) and re-assigned to respective vertices of sublattices of the second subset of sublattices. In the example embodiment illustrated in FIG. 4, the second subset of sublattices includes the third sublattice (e.g., the red sublattice). For example, in an example embodiment one or more of the physical qubits that were used as first plaquette qubits or second plaquette qubits are re-initialized and re-assigned as third vertex qubits (also referred to herein as physical qubits assigned to the vertices of the third sublattice) and/or as ancilla qubits.

At step 212 of FIG. 2, the physical qubits assigned to vertices of the sublattice(s) of the second subset of sublattices are entangled with the plaquette qubits of the respective sublattice.

Continuing with the example embodiment illustrated by FIG. 4, the second subset of sublattices includes the third sublattice (e.g., a red sublattice). As shown in panel 406, the physical qubits assigned to the vertices of the third sublattice (which is a member of the second subset of sublattices) are entangled with the physical qubits assigned to the plaquettes of the third sublattice. The physical qubits assigned to the plaquettes of the third sublattice (also referred to herein as the third plaquette qubits) are entangled with physical qubits assigned to the vertices of the third sublattice (also referred to herein as the third vertex qubits) via an entangling gate. In an example embodiment, the entangling gate is a controlled NOT gate (e.g., a CNOT gate). In another example embodiment, the entangling gate is a controlled Z gate (e.g., a CZ gate).

For example, a third plaquette qubit p₁ is linked and/or directly connected to third vertex qubits v₁, v₂, v₃, v₇, v₈, and v₉ via respective edges of the third sublattice; third plaquette qubit p₂ is linked and/or directly connected to third vertex qubits v₁, v₂, v₃, v₄, v₅, and v₆ via respective edges of the third sublattice; and third plaquette qubit p₃ is linked and/or directly connected to third vertex qubits v₄, v₅, v₆, v₇, v₈, and v₉ via respective edges of the second sublattice. Entangling gates are performed, in various embodiments, to entangle the third plaquette qubits with the third vertex qubits linked and/or directly connected thereto (e.g., via edges of the third sublattice). In various embodiments, the entangling gates may be performed in accordance with the condensed notation circuit 505/expanded notation circuit 510 or in accordance with the reduced circuit 515. For example, when the entangling of the third plaquette qubits with the second vertex qubits is performed in accordance with the reduced circuit 515, instead of performing six two-qubit gates for each plaquette of the third sublattice to entangle the third vertex qubits with the third plaquette qubits, only four two-qubit gates need be performed for each plaquette of the third sublattice.

For example, the controller 30 may control operation of the confinement apparatus 50 (e.g., via controlling operation of the voltage sources 90 that generate and provide voltage signals for application to the electrodes of the confinement apparatus, in an example embodiment) and the manipulation sources 64 to cause performance of entangling gates on pairs of physical qubits in accordance with the condensed notation circuit 505/expanded notation circuit 510 or in accordance with the reduced circuit 515 for each sublattice of the second subset of sublattices.

Continuing with FIG. 2, at step 214, the controller causes the plaquette qubits of the sublattice(s) of the second subset of sublattices to be measured. For example, in the illustrated example where the second subset of sublattices includes the third sublattice (e.g., the red sublattice), the third plaquette qubits are measured. For example, respective qubit states of each of the plaquette qubits of the sublattices that are members of the second subset of sublattices are determined by performing measurement operations thereon. In an example embodiment, the measurement of the plaquette qubits is performed in the X-basis, resulting in a state determination of |+> (e.g., a measurement result of +1) or |−> (e.g., a measurement result of −1). For example, panel 440 of FIG. 4 illustrates the measurement of the plaquette qubits of the sublattice(s) of the second subset of sublattices.

In various embodiments, measuring a physical qubit (e.g., a physical qubit of a QCCD-based quantum processor 115) includes causing a reading manipulation signal that is resonant or near resonant with a particular transition of the physical qubit to be incident on the physical qubit. When the wavefunction of the physical qubit collapses to a first qubit state of the physical qubit, the qubit will fluoresce in response to the reading manipulation signal being incident thereon and when the wavefunction of the physical qubit collapses to a second qubit state of the physical qubit, the qubit will not fluoresce in response to the reading manipulation signal being incident thereon. The optical collection system 80 detects and/or captures any fluorescence generated in response to the reading manipulation signal being incident on the physical qubit. The optical collection system 80 provides sensor signals to the controller 30 (e.g., via A/D converter 725). The controller 30 processes the sensor signals to determine to which qubit state the wavefunction of the physical qubit collapsed.

In various embodiments, the controller 30 processes the sensor signals to determine measurement results for each of the plaquette qubits of the lattice. Based on the measurement results, the controller 30 determines whether any of the plaquettes are hosting an Abelian topological order. For example, the controller 30 determines, based on the measurement of the plaquettes of the lattice (e.g., the plaquettes of sublattice(s) in the first subset of sublattices and the plaquettes of the sublattice(s) in the second subset), whether any plaquettes of the plurality of sublattices are hosting an Abelian topological order. For example, when measurement of a plaquette yields a measurement result of +1, the plaquette is determined to be hosting a non-Abelian topological order and when measurement of a plaquette yields a measurement result of −1, the plaquette is determined to be hosting an Abelian topological order, in an example embodiment.

In an example embodiment, the re-initializes one or more of the third plaquette qubits for use as ancilla qubits after the measurement of the third plaquette qubits.

At step 216, responsive to determining that at least a pair of plaquettes is hosting an Abelian topological, order the controller 30 causes performance of a feed-forward action to be performed on the pair of plaquettes to generate the ground state having non-Abelian topological order. For example, upon processing the sensor signals, the controller 30 may determine that a pair of plaquettes of a particular sublattice is hosting a phase of matter that is an Abelian topological order. The controller 30 may then cause performance of a feed-forward action on the pair of plaquettes to cause each of the pair of plaquettes to host a phase of matter that is a non-Abelian topological order. In various embodiments, the feed-forward action comprises performance of one or more conditional Z gates on the physical qubits assigned to the pair of plaquettes determined to be hosting an Abelian topological order. In various embodiments, the plaquettes of the pair of plaquettes are of the same sublattice (e.g., both of the first sublattice, both of the second sublattice, or both of the third sublattice).

As shown in panel 450 of FIG. 4, multiple pairs of plaquettes may be identified in one or more of the sublattices that are hosting Abelian topological order and feed-forward actions, such as conditional Z-gates, may be performed on each pair to cause the lattice as a whole to host a phase of matter of a non-Abelian topological order.

For example, the controller 30 may control operation of the confinement apparatus 50 (e.g., via controlling operation of the voltage sources 90 that generate and provide voltage signals for application to the electrodes of the confinement apparatus, in an example embodiment) and the manipulation sources 64 to cause performance of conditional Z-gates on pairs of physical qubits assigned to respective pairs of plaquettes based at least in part on a result of processing the measurements of the plaquette qubits.

In various embodiments, the non-Abelian topological order is prepared and/or generated in a ground state thereof. Notably, the non-Abelian topological order may have a plurality of degenerate and distinguishable ground states (e.g., distinguishable based on the results of operating thereon with various operators defined on the lattice). The non-Abelian topological order may be manipulated to cause performance of various quantum computations. For example, concentrations of entanglement (e.g., anyons) may be generated and/or manipulated (e.g., braided) to cause performance of (fault tolerant) quantum computations. For example, the non-Abelian anyons may be used as logical qubits of the quantum processor on which the non-Abelian topological order was prepared.

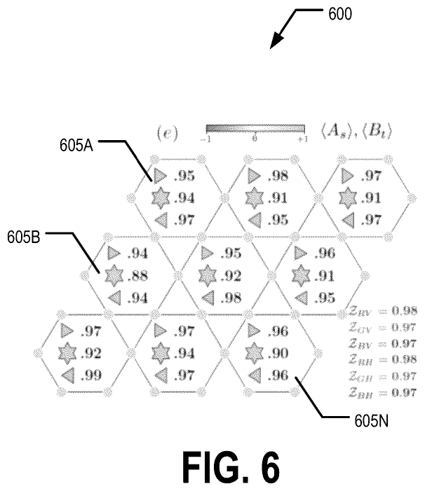

FIG. 6 provides the results of experimental measurements of a prepared ground state of non-Abelian topological order as illustrated in FIG. 4. For example, for lattice 600, the expectation values of the star operator 310 (As) and each triangle operator 315A, 315B (B_{T}) for each of the plaquettes 605 (e.g., 605A, 605B, . . . , 605N) and the logical Z operators are shown. As shown in FIG. 6, the ground state of non-Abelian topological order is deterministically prepared with A_{S}≈B_{T}≈1. Moreover, the ground state of non-Abelian topological order is deterministically prepared (e.g., without need of post selection) while using significantly fewer two-qubit gates compared to a naïve preparation of the non-Abelian topological order.

### Technical Advantages

Complex quantum computations demand levels of precision that are not available in conventional quantum computers due to imperfect control and noise in gate operations between data qubits, for example. Proposed schemes for fault tolerant quantum computing include performing quantum computations on logical qubits that are logically organized based on a selected quantum error correction (QEC) code. Conventional quantum error correction includes the extraction of syndromes which generally includes the interaction of ancilla qubits with data qubits of a logical qubit defined by the QEC code. However, if not performed carefully, such interactions between ancilla qubits and data qubits can cause faults to spread ruinously, leading to logical errors that would have otherwise been correctable given their initial weight. Thus, technical problems exist regarding how to perform quantum computations with levels of precision that are sufficient for performing complex computations.

Various embodiments provide technical solutions to such technical problems. For example, various embodiments provide for the performance of fault tolerate quantum computing and/or fault tolerant quantum error correction using topological quantum computing. Topological quantum computing uses topological order to perform quantum computations. Topological order is a manifestation of long-range quantum entanglement of a plurality of quantum objects, such as the physical qubits. For example, a concentration of entanglement of the underlaying physical qubits forms a quasiparticle referred to as an anyon. For example, anyons are excitations of topological order (e.g., similar to how phonons are excitations of motional modes of matter).

Various embodiments provide for the preparation and/or generation of a ground state of non-Abelian topological order. Non-Abelian topological order is a type of typological order having non-Abelian (e.g., non-commutative) properties. A result of the non-Abelian nature of such a state of matter results in the non-Abelian anyons “remembering” their respective histories. For example, performing Operation A and then performing Operation B on a non-Abelian anyon will provide a different result than performing Operation B and then performing Operation A on the non-Abelian anyon due to the non-commutativity of the non-Abelian topological order. It is expected that these features of non-Abelian topological order will enable performance of fault tolerant quantum computing using non-Abelian anyons and/or various states of non-Abelian topological order.

Classical simulations are not able to simulate systems and/or matter exhibiting non-Abelian topological order. Therefore, in order to test whether these expectations of fault tolerant computing using non-Abelian topological order will come to bear, states of non-Abelian topological order must be generated and empirically investigated. However, conventional and experimentally successful techniques for the preparation and/or generation of states of non-Abelian topological order are not present in the art. Therefore, technical problems exist regarding the preparation and/or generation of states of non-Abelian topological order. Moreover, technical problems exist regarding to determining whether and/or how topologically-protected quantum computing can provide for higher precision quantum computations.

Various embodiments provide technical solutions to these technical problems. For example, various embodiments provide methods, systems, controllers for systems, computer program products for configuring controllers of systems for preparing and/or generating states of a non-Abelian topological order. For example, in various embodiments, a ground state of non-Abelian topological order may be generated using a plurality of physical qubits of a quantum processor, such as a QCCD-based processor. FIG. 6 illustrates the measurement results of an example successful generation of a ground state of a non-Abelian topological order prepared in accordance with an example embodiment. Once prepared, the non-Abelian topological order may be manipulated and/or interacted with to provide various excited states and/or various (other) ground states of the non-Abelian topological order.

For example, due to the limited number of physical qubits available to conventional quantum processors (e.g., generally less than 50), various embodiments implement methods for generating a ground state of a non-Abelian topological order that use reduced number of physical qubits. For example, conventional theoretical techniques for generating a ground state of non-Abelian topological order may require the use of more physical qubits than are available to a conventional quantum processor. Various embodiments reduce the number of physical qubits required to prepare and/or generate the ground state of non-Abelian topological order by performing a sequence of entanglement and measurement operations on a first subset of the sublattices and then re-initializing and re-using one or more of the physical qubits used to perform the sequence of entanglement and measurement operations on the first subset of the sublattices to perform a sequence of entanglement and measurement operations on a second subset of the sublattices.

In another example, various embodiments reduce the number of gates performed to prepare and/or generate a ground state of a non-Abelian topological order such that the depth and the length of time needed to perform a quantum circuit that prepares and/or generates the ground state of the non-Abelian topological order is reduced. For example, physical qubits have a finite coherence time. Therefore, having a very deep quantum circuit (e.g., quantum circuit including a large number of gates) may negatively affect the fidelity with which the ground state of the non-Abelian topological order may be prepared and/or generated. For example, a conventional theoretical technique for generating a ground state of non-Abelian topological order includes performance of 108 two-qubit gates. However, according to an example embodiment, the ground state of non-Abelian topological order is generated using only 78 two-qubit gates.

Therefore, various embodiments provide technical solutions to the technical problems regarding the preparation and generation of a ground state of non-Abelian topological order. Various embodiments therefore provide technical improvements to the fields of fault tolerant and/or topologically-protected quantum computing.

### Example Controller

Various embodiments provide systems comprising confinement apparatuses 50, systems that include a confinement apparatus 50, and/or methods for use thereof. In an example embodiment, the system is a quantum charge-coupled device (QCCD)-based quantum computer 110 or other quantum computer. In various embodiments, the system (e.g., quantum computer 110) further comprises a controller 30 configured to control various elements of the system. For example, the controller 30 is configured to control various elements of the system to prepare and/or generate a ground state of a non-Abelian topological order and/or to use the non-Abelian topological order and anyons thereof to perform quantum computations.

For example, the controller 30 may be configured to control the voltage sources 90, a cryogenic system and/or vacuum system for controlling the temperature and pressure within the cryogenic and/or vacuum chamber 40, manipulation sources 64 (e.g., 64A, 64B, 64C), active components of beam path systems 66 (e.g., 66A, 66B, 66C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum objects (e.g., physical qubits) confined by the confinement apparatus 50, and/or read and/or measure a quantum state of one or more quantum objects confined by the confinement apparatus.

As shown in FIG. 7, in various embodiments, the controller 30 may comprise various controller elements including one or more processing devices 705, memory 710, driver controller elements 715, a communication interface 720, analog-digital converter elements 725, and/or the like. For example, the one or more processing devices 705 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 705 of the controller 30 comprises a clock and/or is in communication with a clock. In various embodiments, this clock defines the clock cycles of the system.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding to the logical and/or physical qubits of quantum computer (e.g., in a qubit record data store, qubit record database, qubit record table, and/or the like), a calibration table, an executable queue, computer program code or executable instructions (e.g., in a one or more computer languages, specialized controller language(s), and/or the like), and/or the like. In an example embodiment, execution of at least a portion of the computer program code or executable instructions stored in the memory 710 (e.g., by a processing device 705) causes the controller 30 to perform one or more steps, operations, processes, procedures and/or the like described herein for controlling one or more components of the quantum computer 110 (e.g., voltage sources 90, manipulation sources 64, magnetic field sources 70, and/or the like) to cause a controlled evolution of quantum states of one or more quantum objects, measure and/or read the quantum state of one or more quantum objects, and/or the like. For example, execution of at least a portion of the computer program code or executable instructions stored in the memory 710 (e.g., by a processing device 705) causes the controller 30 to perform one or more steps, operations, processes, procedures and/or the like of the flowchart of FIG. 2, in an example embodiment.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 705). In various embodiments, the driver controller elements 715 may enable the controller 30 to operate a manipulation source 64. In various embodiments, the drivers may be laser drivers; vacuum component drivers; drivers for controlling the flow of current and/or voltage applied to RF, control, and/or other electrodes (e.g., shim electrodes and/or the like) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes and/or RF electrodes of the confinement apparatus 50.

In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optical collection system 80. For example, the controller 30 may comprise one or more analog-digital converter elements 725 configured to receive signals from one or more detectors, optical receiver components, calibration sensors, and/or the like.

In various embodiments, the controller 30 may comprise a communication interface 720 for interfacing and/or communicating with one or more computing entities 10. For example, the controller 30 may comprise a communication interface 720 for receiving executable instructions, command sets, and/or the like from the computing entity 10 and providing output received from the quantum processor 115 (e.g., via the optical collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

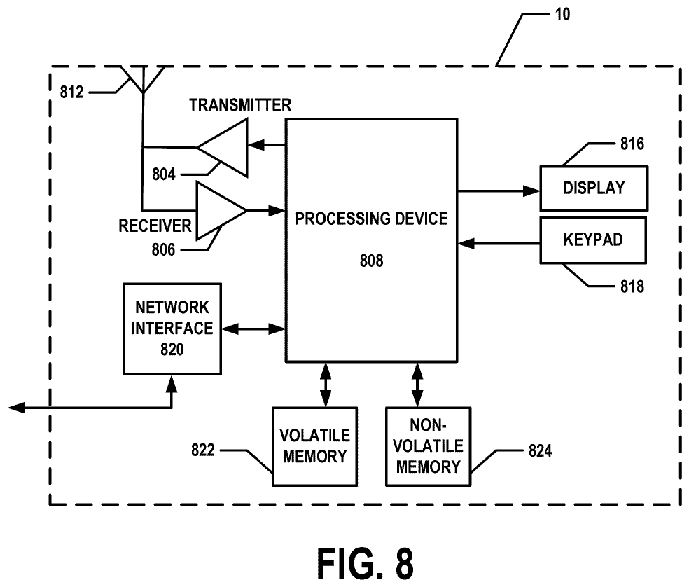

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 8, a computing entity 10 can include an antenna 812, a transmitter 804 (e.g., radio), a receiver 806 (e.g., radio), and a processing device 808 that provides signals to and receives signals from the transmitter 804 and receiver 806, respectively.

The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 820 configured to communicate via one or more wired and/or wireless networks 20.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for generating a ground state having non-Abelian topological order, the method comprising:
causing a plurality of physical qubits to be confined by a confinement apparatus, the plurality of physical qubits being logically organized onto a lattice comprising a plurality of vertices connected by edges and a plurality of plaquettes, wherein the lattice is formed of a plurality of sublattices, wherein each sublattice comprises a respective three or more vertices of the plurality of vertices and a respective one or more plaquettes of the plurality of plaquettes, the respective three or more vertices and the respective one or more plaquettes of a sublattice of the plurality of sublattices are connected by edges to form the sublattice;
causing entanglement of vertex qubits of the plurality of physical qubits assigned to the respective three or more vertices of a respective sublattice in a first subset of sublattices with one or more plaquette qubits of the plurality of physical qubits assigned to the respective one or more plaquettes of the respective sublattice in the first subset of sublattices;
causing measurement of the one or more plaquette qubits assigned to the respective one or more plaquettes of the respective sublattice in the first subset of sublattices;
causing entanglement of physical qubits of the plurality of physical qubits assigned to the respective three or more vertices of a respective sublattice in a second subset of sublattices with one or more plaquette qubits of the plurality of physical qubits assigned to the respective one or more plaquettes of the respective sublattice in the second subset of sublattices;
causing measurement of the one or more plaquette qubits of the respective sublattice in the second subset of sublattices;
determining, based on the measurement of the one or more plaquette qubits of the respective sublattice in the first subset and the measurement of the one or more plaquette qubits of the respective sublattice in the second subset, whether any plaquettes of the plurality of sublattices are hosting an Abelian topological order; and
responsive to determining that at least a pair of plaquettes of the plurality of sublattices is hosting an Abelian topological order, causing performance of a feed-forward action to be performed on the pair of plaquettes to generate the ground state having non-Abelian topological order.

2. The method of claim 1, wherein the one or more plaquette qubits of each sublattice are in product state prior to the entanglement of the vertex qubits of the respective sublattice in the first subset of sublattices with the one or more plaquette qubits of the respective sublattice in the first subset of sublattices.

3. The method of claim 1, wherein causing entanglement of the vertex qubits of the respective sublattice in the first subset of sublattices with the one or more plaquette qubits of the respective sublattice in the first subset of sublattices comprises causing entanglement between a particular plaquette qubit assigned to a particular plaquette of the respective one or more plaquettes and each of three vertex qubits assigned to vertices of the respective three or more vertices that are connected to the particular plaquette via edges of the sublattice and causing entanglement between another particular plaquette qubit assigned to another particular plaquette of the respective one or more plaquettes and the three vertex qubits assigned to the vertices of the respective three or more vertices that are connected to the particular plaquette via the edges of the sublattice, the three vertex qubits are also connected to the other particular plaquette via the edges of the sublattice.

4. The method of claim 3, wherein causing entanglement between a particular plaquette qubit assigned to a particular plaquette of the respective one or more plaquettes and each of three vertex qubits that are each assigned to a respective vertex of the respective three or more vertices and that are connected to the particular plaquette and causing entanglement between another particular plaquette qubit assigned to another particular plaquette of the respective one or more plaquettes and the three vertex qubits that are each assigned to a respective vertex of the respective three or more vertices and that are connected to the other particular plaquette is implemented as four two-qubit gates.

5. The method of claim 1, further comprising, prior to the measurement of the one or more plaquette qubits of the respective sublattice of the first subset of sublattices, causing entanglement of the plurality of plaquettes using pairs of three operator non-Clifford interactions.

6. The method of claim 5, wherein a pair of three operator non-Clifford interactions is implemented as four two-qubit gates.

7. The method of claim 1, wherein the lattice is a Kagome lattice.

8. The method of claim 1, wherein causing the measurement of a plaquette qubit of the one or more plaquette qubits of the respective sublattice comprises determining a quantum state of the plaquette qubit.

9. The method of claim 1, wherein causing performance of the feed-forward action on the pair of plaquettes comprises causing conditional Z gates to be performed on the pair of plaquettes.

10. The method of claim 1, wherein the lattice has periodic boundary conditions.

11. A system configured for generating a ground state having non-Abelian topological order, the system comprising:
a confinement apparatus configured to confine a plurality of physical qubits;
one or more manipulation sources configured to generate respective manipulation signals for interaction with respective physical qubits of the plurality of physical qubits; and
a controller configured to control operation of the confinement apparatus and the one or more manipulation sources, the controller configured to perform:
causing the plurality of physical qubits to be confined by the confinement apparatus, the plurality of physical qubits being logically organized onto a lattice comprising a plurality of vertices connected by edges and a plurality of plaquettes, wherein the lattice is formed of a plurality of sublattices, wherein each sublattice comprises a respective three or more vertices of the plurality of vertices and a respective one or more plaquettes of the plurality of plaquettes, the respective three or more vertices and the respective one or more plaquettes of a sublattice of the plurality of sublattices are connected by edges to form the sublattice;
causing entanglement of vertex qubits of the plurality of physical qubits assigned to the respective three or more vertices of a respective sublattice in a first subset of sublattices with one or more plaquette qubits of the plurality of physical qubits assigned to the respective one or more plaquettes of the respective sublattice in the first subset of sublattices;
causing measurement of the one or more plaquette qubits assigned to the respective one or more plaquettes of the respective sublattice in the first subset of sublattices;
causing entanglement of physical qubits of the plurality of physical qubits assigned to the respective three or more vertices of a respective sublattice in a second subset of sublattices with one or more plaquette qubits of the plurality of physical qubits assigned to the respective one or more plaquettes of the respective sublattice in the second subset of sublattices;
causing measurement of the one or more plaquette qubits of the respective sublattice in the second subset of sublattices;
determining, based on the measurement of the one or more plaquette qubits of the respective sublattice in the first subset and the measurement of the one or more plaquette qubits of the respective sublattice in the second subset, whether any plaquettes of the plurality of sublattices are hosting an Abelian topological order; and
responsive to determining that at least a pair of plaquettes of the plurality of sublattices is hosting an Abelian topological order, causing performance of a feed-forward action to be performed on the pair of plaquettes to generate the ground state having non-Abelian topological order.

12. The system of claim 11, wherein the one or more plaquette qubits of each sublattice are in product state prior to the entanglement of the vertex qubits of the respective sublattice in the first subset of sublattices with the one or more plaquette qubits of the respective sublattice in the first subset of sublattices.

13. The system of claim 11, wherein causing entanglement of the vertex qubits of the respective sublattice in the first subset of sublattices with the one or more plaquette qubits of the respective sublattice in the first subset of sublattices comprises causing entanglement between a particular plaquette qubit assigned to a particular plaquette of the respective one or more plaquettes and each of three vertex qubits assigned to vertices of the respective three or more vertices that are connected to the particular plaquette via edges of the sublattice and causing entanglement between another particular plaquette qubit assigned to another particular plaquette of the respective one or more plaquettes and the three vertex qubits assigned to the vertices of the respective three or more vertices that are connected to the particular plaquette via the edges of the sublattice, the three vertex qubits are also connected to the other particular plaquette via the edges of the sublattice.

14. The system of claim 13, wherein causing entanglement between a particular plaquette qubit assigned to a particular plaquette of the respective one or more plaquettes and each of three vertex qubits that are each assigned to a respective vertex of the respective three or more vertices and that are connected to the particular plaquette and causing entanglement between another particular plaquette qubit assigned to another particular plaquette of the respective one or more plaquettes and the three vertex qubits that are each assigned to a respective vertex of the respective three or more vertices and that are connected to the other particular plaquette is implemented as four two-qubit gates.

15. The system of claim 11, wherein the controller is further configured to perform, prior to the measurement of the one or more plaquette qubits of the respective sublattice of the first subset of sublattices, causing entanglement of the plurality of plaquettes using pairs of three operator non-Clifford interactions.

16. The system of claim 15, wherein a pair of three operator non-Clifford interactions is implemented as four two-qubit gates.

17. The system of claim 11, wherein the lattice is a Kagome lattice.

18. The system of claim 11, wherein causing the measurement of a plaquette qubit of the one or more plaquette qubits of the respective sublattice comprises determining a quantum state of the plaquette qubit.

19. The system of claim 11, wherein causing performance of the feed-forward action on the pair of plaquettes comprises causing conditional Z gates to be performed on the pair of plaquettes.

20. The system of claim 11, wherein the lattice has periodic boundary conditions.
